(19) United States
(12) Patent Application Publication
(10) Pub. No.: US 2026/0311216 A1
(43) Pub. Date: Oct. 8, 2026

(54) USER-CONTROLLED SOURCING DATA CONTROL

(71) Applicant: KAISERSPACE GMBH, Bremen (DE)

(72) Inventors: Gundi KAISER, Worpswede (DE); Andreas DETTERBECK, Hamburg (DE)

(21) Appl. No.: 19/483,344

(22) PCT Filed: May 8, 2024
(86) PCT No.: PCT/EP2024/062840

§ 371 Date: Jan. 14, 2026

(30) Foreign Application Priority Data
May 12, 2023 (DE) 10 2023 112 575.3

(51) Int. Cl. G06Q 30/0251; G06Q 30/0201

(52) U.S. Cl. CPC G06Q 30/0271; G06Q 30/0201

(57) ABSTRACT

A method for user-controlled procurement data control on a terminal includes acquiring user data on the terminal where the user data represents a user and/or a use of the terminal. A requirement dataset is generated on the basis of the user data according to a requirement rule to be predetermined by the user. The requirement dataset represents a procurement wanted by the user in relation to at least one product. A procurement dataset is generated on the basis of the requirement dataset. The procurement dataset represents at least one available procurement of the at least one product.

The present invention relates to methods, computer programs and devices for user-controlled procurement data control using terminals, in particular mobile terminals such as smartphones, tablets and the like.

Digitization in almost all areas of life now offers users of terminals a wide range of opportunities to procure needed products, such as objects or services, flexibly and in a short time. However, the increasing volume of required data flows is leading to problems with regard to data efficiency and security. In conjunction with the generation and provision of procurement data, the demands on the performance of technical data processing equipment have increased significantly. For example, extensive procurement data that is automatically provided to a mobile terminal requires high data transmission capacities and usually powerful graphics processors to display the procurement data adequately. This can undesirably impair the processing speed at the terminal, despite increasingly powerful devices. Furthermore, efficient use and evaluation of the procurement data becomes more difficult, especially when data is received in packets with higher latency times. Real-time processing of the procurement data is then practically impossible.

Another area of concern is the protection of sensitive user data, the misuse of which, whether private or business-related, must be countered as far as possible.

Due to the problems described, it is conceivable to restrict the receipt of procurement data on a terminal. Alternatively, attempts could be made to protect the user data that can be acquired on the terminal from access by third parties through manual settings. However, these measures hinder the potential to make product procurement more efficient and easier by providing users with meaningful procurement data.

It is an object of the invention to provide a method for procurement data control which optimizes the generation of procurement data in the sense of providing accurate and fast information about available procurement options while simultaneously offering better protection of the underlying user data.

The problem is solved by a method having the features of claim 1. Such a method serves for user-controlled procurement data control on a terminal and comprises at least the following steps: acquiring user data on the terminal, the user data representing a user and/or a use of the terminal; generating a requirement dataset on the basis of the user data according to a requirement rule able to be predetermined by the user, the requirement dataset representing a procurement wanted by the user in relation to at least one product; and generating a procurement dataset on the basis of the requirement dataset, the procurement dataset representing at least one available procurement of the at least one product.

One aspect of the solution is that the procurement data is not generated directly on the basis of the regularly very extensive user data, but on the basis of a separately generated requirement dataset. The requirement dataset is generated depending on a requirement rule, which can be predefined by the user. The user therefore has complete control over the extent and form in which their user data is used to generate procurement data. The user data itself may also be partially included in the requirement dataset. In this case, however, the user data in question must “pass” the requirement rule. User data is therefore only used for the generation of procurement data under the conditions specifically defined in the requirement rule.

The solution according to the invention creates user-controlled procurement data control in two respects. Firstly, the user controls the data basis for the procurement data not merely through individual, more or less reliable data protection filters for the user data, but through a holistically designed requirement or data rule that is subject to the user's control. Secondly, the user's requirements for a desired procurement of a product are summarized in a separate requirement dataset, which can be processed independently of other data, especially user raw data, and therefore represents a means of enforcing procurement data control.

The requirement rule preferably serves not merely as a filtering instrument for user data, but enables targeted data transformation with regard to one or more required products. In particular, the requirement dataset generated based on the requirement rule is tailored to efficient and targeted procurement and should therefore preferably not be understood merely as a subset of a large user data pool. Therefore, one aspect of the control solution according to the invention is to not base the procurement dataset directly on the user data, but on the requirement dataset generated for this purpose. In this way, the scope, form, and quality of the procurement data can be directly controlled by the user, which was not possible before.

From the user's perspective, extensive control over the available user data is ensured. The user no longer has to take a passive role as before, allowing extensive user data to flow from the terminal by agreeing to cookies and receiving procurement data that is largely irrelevant and hinders the efficient procurement and efficient use of the terminal. Instead, the user is put in the position to actively request and immediately receive only the procurement data they require. The potential of the available data can still be fully exploited while simultaneously ensuring data control.

The product to be procured can generally be a required item to which specific technical characteristics and parameters are assigned. Alternatively, the product can also be a service, which can also be characterized by technical data, such as in the case of a repair service. Both the service and the item in question are described by procurement data that is relevant to the user and specifies at least one aspect for the possible procurement of the service or product. A product can also be formed from other types of products, e.g., from a foodstuff. The procurement data can also be of a technical nature, e.g., in the form of a weight specification or as geographical and/or temporal availability information for a specific food product.

Embodiments of the invention are disclosed in the claims, the description and the figures.

In one embodiment, the method is wholly or partially computer-implemented. In this context, a distributed execution of the method steps is preferred such that the user data acquirement takes place at least partly on the terminal, in particular using the data processing means of the terminal, such as the processor, the platform (e.g., operating system) and/or the user interface, which is preferably graphical. It is also possible to acquire user data stored internally on the device, which is generated, for example, by the use of software applications installed on the device.

For the purpose of generating the requirement dataset, the user data is preferably transferred to a central server that is assigned to the terminal and is considered particularly trustworthy and secure. The user therefore retains control over these method steps. Alternatively, it is conceivable that the requirement dataset is generated on the terminal itself in order to enforce data control even more strongly.

The procurement dataset is preferably generated on another central server, which, however, does not necessarily have to have the same level of trust as a server responsible for generating the requirement dataset. As a rule, the user will want the requirement dataset to exclude particularly sensitive user data. Accordingly, the data security requirements for processing the requirement dataset can be reduced. However, to ensure maximum data security, it is possible to maintain consistently high requirements, for example by using special data formats and cryptographic methods.

The terminal is preferably a mobile device, e.g., a smartphone, tablet, laptop or other compact data terminal. The terminal is preferably equipped with a display device that has a graphical user interface for controlling the terminal, for example in the form of a touch-sensitive display surface.

According to another embodiment, the requirement rule can be modified by the user. For example, the user can select a desired requirement rule from various predefined requirement rules, which makes the type of modification particularly easy for the user. Alternatively, the user can set one or more sub-rules, e.g., by specifying a data type and/or restricting the user data that can be used for the requirement dataset. Conversely, certain parts of the user data can be excluded from the generation of the requirement dataset. The requirement rule can therefore comprise selective filtering of user data.

Preferably, the requirement rule comprises a sub-rule for transforming the user data. The transformation can be designed in such a way that the requirement data goes beyond the user data as such. In other words, the requirement dataset does not merely comprise subsets of the user data, but also data derived from the user data, which can therefore represent the result of an automated analysis of the user data. The requirement dataset can therefore be significantly more powerful than the user data itself. The user still retains control over which information is released. For this purpose, the requirement rule can also be applied to the generated requirement dataset by analyzing it and, if necessary, removing unwanted sub-data from the requirement dataset.

The requirement rule can exhibit a machine learning model with regard to the aforementioned aspect of data transformation. This also allows complex dependencies within user data to be exploited. The requirement datasets can still be generated quickly with a small and meaningful amount of data. The model is preferably designed to be self-learning, i.e., the model is continuously improved through use and feedback from the user.

Several variants are conceivable for the model type used in the requirement rule. Good results are usually achieved with a neural network, especially a convolutional neural network (CNN).

In a preferred embodiment, user data is acquired on the terminal using a progressive web app (PWA). This enables data acquirement on the terminal even without an existing data communication connection (offline), while still allowing user-friendly control from the browser. In this case, it is advantageous to forgo installing an app. The user data acquired via PWA is preferably transferred from the terminal to a central server where the requirement dataset is generated. Alternatively or additionally, user data can be acquired by the operating system of the terminal, wherein the operating system may have one or more acquirement programs for this purpose.

According to another embodiment, the requirement rule stipulates that the generation of the requirement dataset depends on active input from the user at the terminal. In this way, the user can directly control when and, if applicable, under what circumstances a requirement dataset is generated. For example, the user's input can include a specification about when the requirement dataset should be generated and what conditions must be met for the desired procurement and the product in question. Active input thus promotes the goal of user-controlled control. The control can also consist, in particular, of not receiving unsolicited or irrelevant procurement data on the terminal, as specified by the user.

The user input preferably includes user authentication data, such as a password or a biometric identifier (e.g., a fingerprint or a facial photograph of the user). The security of the process can be further increased in this way.

According to another embodiment, the generation of the procurement dataset depends on validity data, which represent a time-limited validity of the requirement dataset. Additionally or alternatively, the provision of the procurement dataset to the terminal can be made dependent on the validity data. This reduces the data transmission requirements. Secondly, the accumulation of unnecessary or irrelevant procurement data on the terminal is avoided.

As explained, the inclusion of validity data in procurement data control also serves to improve data security. According to a further embodiment, it may be provided that a respective requirement dataset is generated in a non-storable data format. Immediate processing of the data can be enforced in this way. This makes the provision of irrelevant or delayed procurement datasets at least less likely. At the same time, misuse of the data becomes more difficult. Furthermore, the requirement dataset and any validity data should preferably not be modifiable. This feature is also suitable for improved procurement data control.

To further increase data security, it is preferable to provide the requirement dataset in encrypted form on a central server. This could be, in particular, the server that generates the procurement dataset. If user data is also transferred to a central server, it can be encrypted using known cryptographic methods to increase security and protect it from unauthorized access.

In another embodiment, the procurement dataset is made available at the terminal depending on authorization data. The source of the procurement dataset is verified or authenticated in this way. This can counteract the processing of incorrect or insecure procurement data on the terminal. In one embodiment, the authorization data can be formed by an authentication code, which is initially part of the requirement dataset and is transferred to the procurement dataset as proof of authorization.

According to a further embodiment, the requirement dataset is generated depending on at least one data profile, which can be selectively activated and/or modified by the user. For example, the user can select a data profile from a number of predefined data profiles to activate it and use it as the basis for generating the requirement dataset.

The data profile serves to improve the control of the process and is preferably taken into account when executing the requirement rule.

The procurement datasets can also be generated depending on a data profile, wherein each procurement dataset can be directly adapted to the underlying requirement dataset via the data profile.

The data profile preferably defines a priority for a predetermined lead data type of the requirement and/or procurement dataset. The lead data type therefore serves to structure the data and represents an aspect of the desired procurement (in the case of the requirement dataset) or the available procurement (in the case of the procurement dataset) that is highlighted for the user. Preferably, the lead data type is formed by one of the following data types: location data; time data; image, video, and/or audio data; or specification data.

According to another embodiment, the user data and/or the requirement dataset have at least one of the following data types: location data, in particular concerning an area of a desired delivery; time data; image, video, and/or audio data; procurement data previously provided on the terminal; and/or specification data. In terms of content, the user data represents at least one aspect of the desired procurement, e.g., a geographical area in which the required product is to be procured (location data); a time window within which the product is to be procured (time data); a photo, a filmic or an acoustic description of the desired product or similar products to be procured (image, video, and/or audio data). The user data or the requirement dataset can therefore contain specific requirements of the desired procurement. The procurement data generated as a result can be tailored in such a way that products which are available but violate one of the aforementioned requirements are not included in the procurement dataset.

The user data may have been entered on the terminal currently or in the past, particularly when using one or more apps installed on the terminal. User data can also be acquired automatically, but preferably user-controlled, on the terminal, i.e., the user can exclude certain types of user data from acquirement and subsequent processing from the outset. On the other hand, user data that the user did not directly enter can be derived as additional user data. For example, user data can be used to determine information about potentially needed products, especially by using powerful machine learning models. Furthermore, procurement data and/or information about products actually procured, previously provided on the terminal, can be incorporated, directly or in derived form, into the newly generated requirement dataset as user data.

According to another embodiment, the procurement dataset comprises at least one of the following data types: location data, in particular concerning an area of possible delivery of an available product; time data; image, video, and/or audio data (e.g., a static or dynamic image of the product); specification data (e.g., a size of the product or a quantity of the product); and/or delivery data (e.g., a price of the product). In terms of content, the aforementioned data types represent at least one aspect of the available procurement of a product, in particular adapted to the specifications of the requirement dataset. The product in question can be exactly the same as the product requested according to the requirement data, or it can be a similar product. In general, a procurement dataset can also specify available procurement options for multiple products.

The procurement dataset should generally be aligned with the requirement dataset. The adjustment can relate to both the data content and the data format. For example, matching between datasets can be achieved by using data profiles with matching data types, as described above. Furthermore, it is preferred that there be a unique assignment between a requirement dataset and a procurement dataset generated on this basis, which can be taken into account when providing the procurement dataset to the terminal.

For the purpose of efficient procurement data control, the procurement dataset can be generated depending on a predetermined procurement data rule. The procurement data rule is adapted to optimize the match between the desired procurement and an available procurement based on the requirement dataset and a product dataset. The product dataset represents at least one available product that can be procured by the user and can therefore be communicated to the user via procurement data. The match between the requirement data and the product data can be maximized, for example, by hierarchically checking one or more optimization conditions.

According to another embodiment, the procurement dataset is generated on the basis of a large number of predetermined procurement datasets that are stored in a database. Procurement datasets can be generated particularly efficiently and quickly in this way because they are available at least in a rough draft or already in a final form. In the simplest case, a procurement dataset only needs to be selected or slightly modified. The generation of the dataset is then particularly efficient.

According to a further aspect, the invention relates to a method for generating a requirement dataset for user-controlled procurement data control with a terminal. The method comprises, firstly, the acquirement of user data on the terminal, wherein the user data represents a user and/or a use of the terminal. Secondly, a requirement dataset is generated based on the user data, depending on a requirement rule that can be predefined by the user.

As described above, the requirement dataset represents a procurement request from the user for at least one product. The requirement dataset preferably forms the basis for the generation of a procurement dataset that represents at least one available procurement of the product. The requirement dataset can be provided on a central server for this purpose. Preferably, the steps of the method are carried out using different data processing units, in particular in such a way that the user data is acquired at the terminal and the requirement dataset is generated on a central server that receives the user data from the terminal. The requirement dataset can then be transmitted to another central server for the purpose of generating the procurement dataset.

With regard to the aspect of generating the procurement data as such, the invention, according to a further aspect, relates to a method for generating a procurement dataset for user-controlled procurement data monitoring with a terminal. The method comprises at least the following steps: receiving a requirement dataset that is generated based on user data depending on a requirement rule that can be predefined by the user. The requirement dataset represents-as before-a procurement of the at least one product desired by the user. Likewise, user data represents a user and/or a use of the terminal. The method also includes the generation of a procurement dataset based on the requirement dataset.

The procurement dataset represents at least one available procurement of at least one product, which, as described, may consist of an item, a service, or a food product. Preferably, all steps of the method are performed on a central server. In this case, the server can receive the requirement dataset from a second server and provide the procurement dataset directly or indirectly (e.g., via the second server) to the terminal.

Preferably, the procurement dataset is generated on the basis of a product dataset that represents at least one available product for the desired procurement. The product dataset can generally be received from another central server that generates product datasets or queries a database.

According to another aspect, the invention relates to a method for generating a product dataset for user-controlled procurement data control with a terminal. The method comprises at least the following steps: receiving a requirement dataset that is generated based on user data depending on a requirement rule that can be predefined by the user. The requirement dataset represents, as before, a procurement of at least one product desired by the user. As in conjunction with the aspects already described, user data represents a user and/or a use of the terminal.

The method further stipulates that a product dataset is generated based on the requirement dataset. The product dataset generally contains information about available products and is therefore used to generate a procurement dataset. Preferably, the method is executed on a central server that is separate from a second server on which the procurement dataset is generated.

It should be understood that the described methods can each be designed as computer-implemented methods, i.e., all or at least some of the method steps are carried out by a computer in the broadest sense. The respective computer or computer-like unit can be formed by a central server or a part thereof. The user's terminal also represents a computer that executes the assigned method steps in a computer-implemented manner.

It is also understood that each of the described methods can be embodied by a computer program, wherein the instructions of the computer program, when executed on a computer, cause it to perform the steps of a method according to at least one of the embodiments disclosed above.

Another aspect of the invention relates generally to a device that is connected to at least one electronic data processing means and a non-volatile memory. The memory contains a computer program of which the instructions, when executed by the at least one data processing means, cause it to execute the steps of a method according to at least one of the embodiments disclosed above. The device can be formed in particular by a terminal or a central server. Furthermore, it should be understood that if the method steps are carried out in a distributed manner on different devices, a corresponding system can be formed that serves to implement user-controlled procurement data control.

The described methods are preferably designed to be capable of real-time operation. For example, the time span between the generation of the requirement dataset and the subsequent provision of the associated procurement dataset can be less than 500 milliseconds. This assumes a typical data transmission speed of a mobile network. However, other values may also apply.

The features disclosed in conjunction with the first described method, in particular in conjunction with the individual embodiments, may also be implemented in a corresponding manner in each of the other described methods. In other words, the features of the embodiments can be implemented in a corresponding manner in the other methods.

For the sake of clarity, the above explanations assume a requirement dataset is used to generate a procurement dataset. However, it is of course possible to execute the method in a similar manner with multiple requirement datasets and/or procurement datasets.

The described aspects of the invention are below described by way of example only, with reference to the drawings, which show the following:

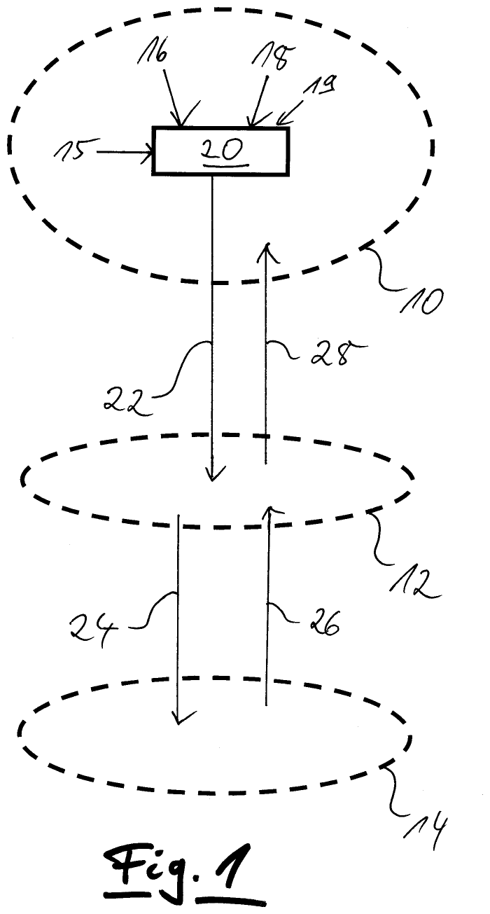

FIG. 1 shows a first scheme to illustrate aspects of a method for user-controlled procurement data control;

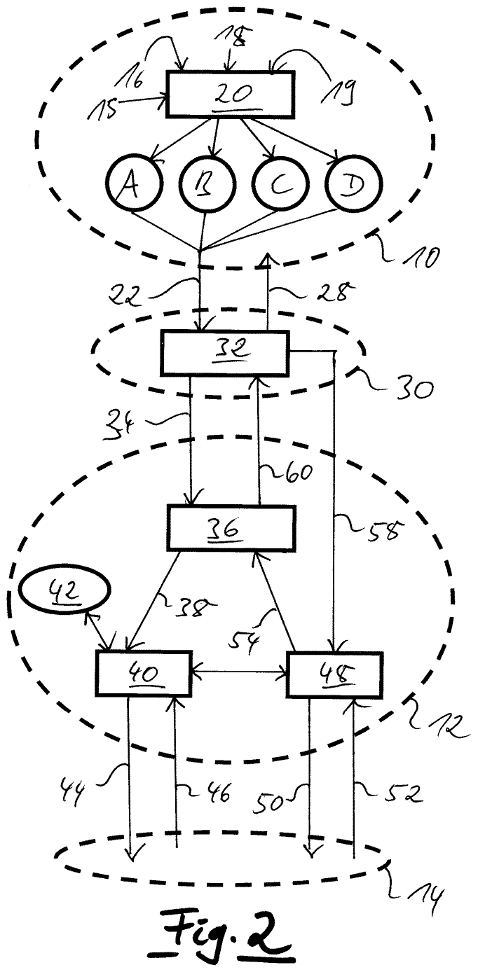

FIG. 2 shows a second scheme to illustrate aspects of the user-controlled procurement data control method from FIG. 1; and

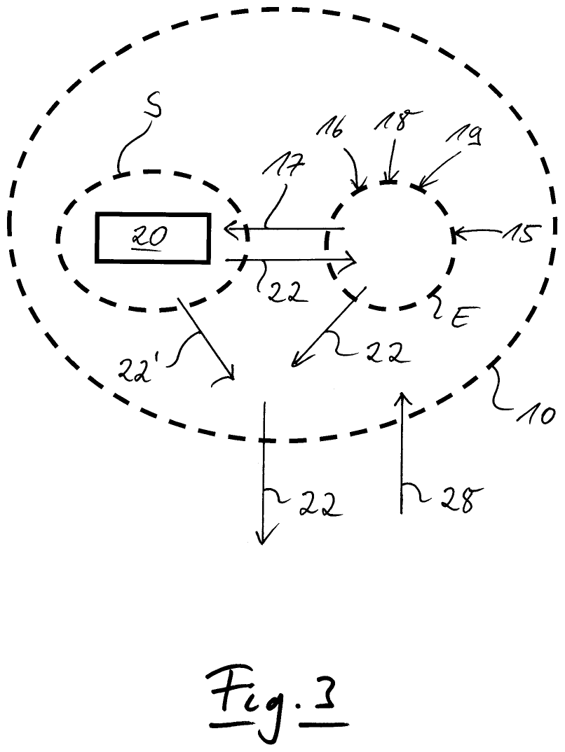

FIG. 3 shows a third scheme to illustrate aspects of the user-controlled procurement data control method from FIG. 1.

Functionally identical elements are marked with the same reference signs.

A method for user-controlled procurement data control is first described with reference to FIG. 1.

At the beginning of the method, user data 16 and usage data 18 are acquired within a usage instance 10. The usage instance 10 comprises at least one mobile electronic device that is regularly operated and controlled by a user for various purposes, in particular to procure required products or at least to initiate the procurement. The terminal can be, for example, a smartphone.

The user data 16 comprises in particular data that characterize the user as such, e.g., in the form of personal characteristics of the user (e.g., age, gender, purchasing power, marital status and/or attitudes and interests with regard to required products). However, the user data 16 may also contain direct specifications regarding products that are fundamentally required and/or their procurement, e.g., in the form of specification data of required products or location data that describe a desired delivery area for a product.

The usage data 18 primarily includes data related to the direct use of the terminal, wherein the usage data 18 can be divided into two groups. Firstly, usage data 18 results from the user's operation, such as the apps used or websites visited, the data content exchanged in the process, and the usage time. Additional data representing usage patterns can also be used.

Another part of the data acquired at the terminal relates to any procurement datasets 19 that were made available at the terminal. These provide information about the range of required products and other associated detailed information. The earlier procurement datasets 19 may contain, in addition to specification data that describe the product as such, advertising data, for example in the form of brand names and/or offer prices.

The usage data 18 may also contain information about products that were actually procured by the user in response to procurement data 19 provided. The usage data 18 thus provide information about the relevance of procurement datasets 19 that were provided to the terminal in the past.

The user data 16, the usage data 18 and the previous procurement data 19 are processed with a requirement rule 20 to generate a requirement dataset 22. The requirement rule 20 comprises a machine-trained model, in particular a neural network, which is stored and executed on a central server S of the usage instance 10 (see FIG. 3).

The execution of the requirement rule 20 depends on input data 15, which is entered by the user on the terminal. The requirement dataset 22 is therefore only generated after approval by the user. This permission can optionally be granted in the form of a permanent permission, e.g., in the form of a flag that can be set by the user. Preferably, the input data comprises 15 authentication details of the user.

In the interest of high data control, the requirement rule 20 is distinguished by the fact that it can be predefined by the user and modified as needed. For example, in conjunction with initial or subsequent training of requirement rule 20, the user can decide which data should be used for this purpose. Accordingly, the user can directly configure which parts of the user data 16, usage data 18 and procurement data 19 available on the terminal should be used to generate the requirement dataset 22. Alternatively or additionally, the requirement rule 20 can have a downstream filtering stage such that unwanted data components in a generated requirement dataset 22 are detected and automatically removed before being transmitted to another server. The filtering level can be set directly by the user, e.g., by specifying data groups that should not be part of the requirement data (e.g., no personal data such as age or interests, which may, however, be part of the user data 16).

The requirement dataset 22 preferably contains only information about one or more products that the user actually wants to procure. In other words, the information contained in the requirement dataset 22 relates exclusively to products that fall within a range of needs requested by the user. However, further data, such as data only remotely related to the product or its procurement, which could dilute the requirement dataset 22 in this way, are not included. The data processing resources required for the transmission of the requirement dataset 22 and its evaluation can therefore be dimensioned accordingly smaller. Alternatively, a higher number of requirement datasets 22 can be generated and processed. These can originate in particular from various usage instances.

For further processing, the requirement dataset 22 is transmitted from the usage instance 10 to a procurement data instance 12. The requirement dataset 22 was preferably encrypted beforehand to prevent data misuse.

The procurement data instance 12 comprises a central server (not shown) that evaluates the requirement dataset 22 in a computer-assisted manner and generates a requirement and provision dataset 24. The dataset 24 is extended compared to the requirement dataset 22 by provision data, which concerns aspects of the technical provision of a procurement dataset 28 to be generated at the usage instance 10. For example, the provision data may contain a data type for the procurement dataset 28 that is not directly specified in the requirement dataset 22.

The requirement and provisioning dataset 24 is provided to a product data instance 14, which generates a product dataset 26 based on this dataset 24. The product dataset 26 represents both data of a product to be procured according to the requirement dataset 22, and data relating to the possible procurement, such as location data that specifies a desired delivery location for the product. Any boundary requirements for the procurement dataset 28 that arise from the provision data can also be taken into account by the product data instance 14 when generating the product dataset 26.

The product dataset 26 is transmitted from the product data instance 14 to the procurement data instance 12, which then generates procurement dataset 28 based on this information. The procurement dataset 28 is then made available at the usage instance 10 and, in particular, transferred to the terminal.

The procurement dataset 28 is at least partially evaluated and displayed on the terminal in order to inform the user about one or more available procurement options. The user can then decide whether or not to initiate the procurement of a product.

The separately generated requirement dataset 22 ensures to a high degree that the procurement dataset 28 meets the user's requirements for their desired procurement. The procurement dataset 28 is therefore highly relevant for the user and thus facilitates the efficient procurement of products. Furthermore, procurement datasets 28 are provided in response to an active request, thereby avoiding the generation and transmission of redundant procurement data.

The following section describes further aspects that shape the user-controlled procurement data control method of FIG. 1, with reference to FIG. 2.

The generation of the requirement dataset 22 is based on a predetermined data profile. The user can select from one of the data profiles A, B, C or D. The relevant selection is taken into account as part of the input data 15 during the execution of the requirement rule. The available options are a location data profile A, a time data profile B, an image data profile C and a specification data profile D.

The location data profile A defines location data as the primary data type for the requirement dataset 28. This can be done in particular by requiring that the available procurements of one or more products must be deliverable in an area specified by the location data, for example by personal collection or by delivery to a location specified by the user. Therefore, at least one position-related boundary condition is defined, which is incorporated into the correspondingly structured requirement dataset 22.

Alternatively, time data profile B can be selected, according to which predetermined time data has the highest priority over other data types. For example, the time data profile B can require that for each available product offered via a procurement dataset, a date of first availability be specified. It can also be stipulated that procurement opportunities older than a predetermined date are excluded from procurement dataset 28 from the outset. In this way, the user can highlight the currency of the available procurement options. This can be particularly useful if the user is already well informed about the procurement options available so far and therefore does not need them.

Image data profile C is available as another option. This allows the user to prioritize image data for the procurement dataset 28 to be generated. For example, the user can take a photo of a required product and/or an identification element attached to the product (such as a product number or a logo). The photo can be included in the requirement dataset 22 as part of the usage data 18 via the requirement rule 20. The product can then be detected using the image data from the procurement data instance 12 and/or the product data instance 14. This ensures that the procurement dataset 28 contains an available procurement for the detected product. The image data can also be formed from image sequences, i.e., video data. The image data profile C can then also be referred to as the video data profile. Furthermore, it is conceivable to use acoustic signal data for the data profile as an alternative or supplement to image or video data in order to describe the product acoustically.

Furthermore, the specification data profile D makes it possible to include a user-defined specification data type as a mandatory boundary condition in the requirement dataset 22. The specification data type can be defined, for example, in the form of a product category (such as a raw material) or a specific product (raw material XY). Accordingly, it is ensured that the procurement dataset provided below contains 28 procurement options tailored to this purpose, which are offered to the user.

It should be understood that the selected data profile affects not only the requirement dataset 22, but also the associated procurement dataset 28. For example, it may be provided that the data type prioritized by the data profile is brought to the foreground when the procurement dataset 28 is displayed on the terminal by activating a corresponding display profile. For example, in the case of location data profile A, the locations of the various available procurements can be summarized in one map. This gives the user a good overview of where the desired product can be obtained. In the case of time data profile B, the procurement options can be sorted according to their currency.

In contrast to FIG. 1, the requirement dataset 22 according to FIG. 2 is first transmitted to a provisioning instance 30, through which the requirement dataset 22 and the procurement dataset 28 are exchanged or mediated between the usage instance 10 and the procurement data instance 12. The provisioning instance 30 can be considered, alongside the procurement data instance 12, as a further instance for implementing procurement data control.

The provisioning instance 30 is preferably formed by a separate, central server, which can be assigned to the procurement data instance 12. However, it is also possible to integrate the functions into the procurement data instance 12, for example by implementing the functions of the provisioning instance 30 and the procurement data instance 12 through a single server. Alternatively, it is conceivable to dispense with the provisioning instance 30, as indicated in FIG. 1.

The provisioning instance 30 generates a first request and mediation dataset 34 and a first provisioning dataset 58 using a provisioning rule 32.

The first requirement and mediation dataset 34 is extended compared to the requirement dataset 22 by information that is relevant for the generation and provision of the procurement dataset 28. For example, in the case of multiple provision instances 30 and procurement data instances 12, it can be specified to which relevant procurement data instance 12 the dataset 34 must be transmitted and to which relevant provision instance 30 the procurement data to be generated must be transmitted. Such mediation data generally serves for the coordinated generation and provision of procurement datasets. For example, it can be avoided that multiple redundant procurement datasets 28 are created and provided in response to a requirement dataset 22. Furthermore, the provisioning instance 30 can check whether the procurement dataset 28 is valid and may be provided to the usage instance 10.

The first provision dataset 58 represents data-technical aspects related to the provision and form of the procurement dataset 28. For example, the data type specified according to the selected data profile A, B, C, or D can be included in the first provisioning dataset 58 and transmitted directly to the procurement data instance 12. Other data can also be derived from the requirement dataset 22 and transmitted as “procurement data parameters” to the procurement data instance 12 independently of the first requirement and mediation dataset 34. This enables, among other things, the accelerated generation and provision of the procurement dataset 28.

Within the procurement data instance 12, the first requirement and mediation dataset 34 is processed using a mediation rule 36. Here, predetermined mediation data is used to check whether further processing is possible and whether a suitable procurement dataset 28 can be generated. If applicable, a second requirement and mediation dataset 38 is generated, which is subsequently processed using a procurement data rule 40.

The procurement data rule 40 is designed to maximize the match between the desired procurement of a product and the available procurement of the product. The rule 40 can employ a machine-learned model for this purpose, e.g., as a neural network.

The procurement data rule 40 cooperates with an authorization data rule 48, which within the procurement data instance 12 represents a third pillar for enforcing user-controlled procurement data control and is implemented together with the procurement data rule 40 by a machine-learned model.

The authorization data rule 40 is adapted to ensure the provision of the generated procurement data in accordance with the requirement dataset 22. For example, unsuitable or invalid procurement datasets can be excluded from forwarding to the provisioning instance 30. Furthermore, the authorization of the provisioning instance 30 to receive a procurement dataset can be verified.

Using the procurement data rule 40 and the authorization data rule 48, a first procurement and mediation dataset 54 is generated. The data processing circuits involved are described in more detail below.

The procurement data rule 40 comprises a query on a procurement database 42, in which a large number of predetermined procurement datasets are stored. If it is determined that a suitable procurement dataset is available, it is read from the procurement database 42 and used as the basis for generating the first procurement and mediation dataset 54. If no suitable procurement dataset is available, a second requirement dataset 44 is generated and transmitted to the product data instance 14.

The second requirement dataset 44 contains in particular the data of the first requirement dataset 22, e.g., in the form of specification data and location data for a product to be procured. The product data instance 14 generates a specification dataset 46 based on the second requirement dataset 44, which describes a procurable product and is transmitted to the procurement data instance 12. The specification dataset 46 can be considered as part of a product dataset 26 (see FIG. 1).

The specification dataset 46 serves the procurement data rule 40 to generate a procurement dataset, which forms a component of the first procurement and mediation dataset 54. The procurement data rule 40 also takes into account an availability dataset 52 and a second provision dataset 50, as further described below.

The second provisioning dataset 50 is transmitted to the product data instance 50 depending on the authorization rule 48 to determine whether the required provisioning data is available for the generation of the procurement dataset. In response to receiving the provisioning dataset 50, the product data instance 14 transmits an availability dataset 52 to the procurement data instance 12. The availability dataset 52 provides information about one or more available procurement options, which are a prerequisite for generating a suitable procurement dataset. Furthermore, the availability dataset 52 indicates whether the specifications of the provision dataset 50 can be met and the procurement dataset can be generated and provided accordingly.

The first procurement and mediation dataset 54 is further processed using the mediation rule 36 and, after checking the mediation requirements, is transferred to a second procurement and mediation dataset 60, which is transmitted to the mediation instance 30.

Using the provisioning rule 32, it is then checked whether the prerequisites for providing the procurement dataset 28 are met. If applicable, the mediation information is removed from the dataset 60 and the resulting procurement dataset 28 is transmitted to the usage instance 10. The procurement dataset 28 is hereby made available to the terminal.

The prerequisites for provision may, for example, consist of adhering to a provisioning time required in accordance with the requirement dataset 22 and/or demonstrating an assignment of the procurement dataset 28 to the requirement dataset 22. The data required for this can be contained, at least partially, in the procurement and mediation dataset 60 as mediation information, e.g., in the form of validity and/or authentication data. However, this information is not transmitted to the usage instance 10. The amount of data provided there is therefore limited to the data that has been specifically requested. The need for transmission bandwidth is minimized accordingly. Preferably, the procurement dataset 28 is encrypted before being transmitted to the usage instance 10 in order to ensure the protection of the procurement dataset 28.

It is to be understood that the usage instance 10, the provisioning instance 30, the procurement data instance 12 and the product data instance 14 form a networked system for realizing user-controlled procurement data control. The instances 10, 12, 14 and 30 can be connected to each other via electronic communication links. The connection between the usage instance 10 and the provisioning instance 30 is preferably wireless. This is particularly useful for mobile terminals. The connections between the instances 30, 12 and 14 are preferably wired to maximize transmission speed and data security.

With reference to FIG. 3, further aspects of user-controlled procurement data control are described below.

The data 15, 16, 18 and 19 is acquired at the terminal E and transmitted as terminal data 17 to the central server S. The server S, like the terminal E, is assigned to the usage instance 10. However, they can be spatially separated and connected to each other via a wireless communication link of a mobile network.

The server S is considered particularly trustworthy and secure with regard to data security. The data 17 can optionally be encrypted before transmission in order to counteract misuse of the data as much as possible.

In one embodiment, the generated requirement dataset 22 can first be transmitted to the terminal E and from there forwarded to the external instances 30 and 12. The user retains direct control over the forwarding of the requirement dataset 22. Alternatively, the requirement dataset can be sent directly from the server S to the external instances 30 and 12. This case is indicated in FIG. 3 by the reference sign 22′. In this case, the forwarding can also be controlled by the user by transmitting a corresponding release from the terminal E to the server S via the input data 15.

### LIST OF REFERENCE SIGNS

10 Usage instance
12 Procurement data instance
14 Product data instance
15 Input data
16 User data
17 Device data
18 Usage data
19 Previous procurement data
20 Requirement rule
22 First requirement dataset
22′ First requirement dataset
24 Requirement and provisioning dataset
26 Product dataset
28 Procurement dataset
30 Provisioning instance
32 Provisioning rule
34 First requirement and mediation dataset
36 Mediation rule
38 Second requirement and mediation dataset
40 Procurement data rule
42 Procurement database
44 Second requirement dataset
46 Specification dataset
48 Authorization rule
50 Second provisioning dataset
52 Availability dataset
54 First procurement and mediation dataset
58 First provisioning dataset
60 Second procurement and mediation dataset
A Location data profile
B Time data profile
C Image data profile
D Specification data profile
E Terminal
S Central server

1. A method for user-controlled procurement data control on a terminal, comprising:
acquiring user data on the terminal (E), the user data representing a user and/or a use of the terminal (E);
generating a requirement dataset on the basis of the user data according to a requirement rule predetermined by the user, the requirement dataset representing a procurement wanted by the user in relation to at least one product; and
generating a procurement dataset on the basis of the requirement dataset, the procurement dataset (28) representing at least one available procurement of the at least one product.

2. The method according to claim 1, wherein the requirement rule is modifiable by the user and has selective filtering of the user data, and wherein the requirement rule comprises a machine learning model.

3. The method according to claim 2, wherein the user data is acquired on the terminal (E) using a progressive web app and/or an operating system of the terminal (E) and is transmitted from the terminal (E) to a central server (S), and wherein the requirement dataset is generated on the central server(S).

4. The method according to claim 3, wherein the requirement rule provides that the generation of the requirement dataset takes place depending on an active input of the user at the terminal (E), and wherein the input comprises authentication data of the user.

5. The method according to claim 1, wherein the generation of the procurement dataset or its provision to the terminal (E) is dependent on validity data that represent a time-limited validity of the requirement dataset.

6. The method according to claim 1, wherein the requirement dataset is provided in encrypted form to at least one central server.

7. The method according to claim 1, wherein the procurement dataset is provided to the terminal (E) depending on authorization data.

8. The method according to claim 1, wherein the requirement dataset or the procurement dataset is generated depending on at least one data profile (A, B, C, D) which can be selectively activated and/or modified by the user.

9. The method according to claim 8, wherein the data profile (A, B, C, D) specifies a priority for a predetermined lead data type of the requirement dataset or the procurement dataset, wherein the lead data type represents an aspect of the desired or available procurement prioritized for the user and is formed by one of the following data types:
location data;
time data;
image, video, or audio data;
specification data.

10. The method according to claim 1, wherein the user data or the requirement dataset have at least one of the following data types and represent at least one aspect of the desired procurement:
location data concerning an area of a desired delivery;
time data;
image, video, or audio data;
procurement data previously provided on the terminal;
specification data.

11. The method according to claim 1, wherein the procurement dataset has at least one of the following data types and represents at least one aspect of the available procurement:
location data concerning an area of available delivery;
time data;
image, video, or audio data;
specification data;
delivery data.

12. The method according to claim 1, wherein the procurement dataset is generated depending on a predetermined procurement data rule which is adapted to optimize a match between the desired procurement and an available procurement based on the requirement dataset and a product dataset, and wherein the product dataset represents at least one available product.

13. The method according to claim 1, wherein the procurement dataset is generated on the basis of a large number of predetermined procurement datasets that are stored in a database.

14-18. (canceled)

19. A method for generating a procurement dataset for user-controlled procurement data control with a terminal (E), comprising at least the following steps:
receiving a requirement dataset generated on the basis of user data depending on a requirement rule predetermined by the user, wherein the requirement dataset represents a procurement of at least one product requested by the user, and wherein the user data represent a user and/or a use of the terminal (E); and
generating a procurement dataset on the basis of the requirement dataset the procurement dataset representing at least one available procurement of the at least one product.

20. The method according to claim 19, wherein the procurement dataset is generated depending on at least one data profile (A, B, C, D) that is contained in the requirement dataset.

21-22. (canceled)

23. A device for user-controlled procurement data control, wherein the device is connected to at least one data processing means and a non-volatile memory in which at least one computer program is stored, wherein the computer program comprises instructions which, when executed by the at least one data processing means, cause the at least one data processing means to execute the steps of the method according to claim 1.

24. The method according to claim 1, wherein the requirement dataset is generated in a non-storable data format and is not modifiable.

25. The method according to claim 8, wherein the data profile is selected from a number of predetermined data profiles (A, B, C, D).

26. The method according to claim 19, wherein the method is executed on at least one central server.
